(19) United States
(12) Patent Application Publication
(10) Pub. No.: US 2018/0133537 A1
(43) Pub. Date: May 17, 2018

(54) KETTLEBELL WITH INTEGRATED MOTION SENSORS AND KINETIC CHARGING SYSTEM

(71) Applicant: Fujitsu Limited, Kawasaki-shi (JP)

(72) Inventor: James Montantes, San Jose, CA (US)

(21) Appl. No.: 15/352,313

(22) Filed: Nov. 15, 2016

(51) Int. Cl. A63B 21/072; A63B 21/00; A63B 24/00; A63B 71/06; A63B 23/12; H02J 7/00

(52) U.S. Cl. CPC A63B 21/072; A63B 21/4035; A63B 24/0062; A63B 71/0622; A63B 23/12; A63B 2207/02; H02J 7/0052; A63B 2220/833; A63B 2220/803; A63B 2220/40; A63B 2225/50; A63B 21/0004

(57) ABSTRACT

A kettlebell includes sensors to collect movement data during use, a controller to track movement data, a kinetic charging circuit to charge a kettlebell battery, a network interface over which to transmit movement data to a networked device, and a user interface to display a representation of electricity generated by the kettlebell movement. The sensors include an accelerometer or a gyroscope. The controller may execute instructions to store the movement data, sample or aggregate the data, transmit the sampled or aggregated data to the networked device, determine the amount of electricity generated by kettlebell movement, or calculate a measure of exercise intensity based on the generated electricity. The networked device may generate and provide data representing the effectiveness of a user's fitness program to a cloud-based server or exchange the data with another networked device. The server may provide the data to a fitness professional or another user.

### BACKGROUND

### Field of the Disclosure

The present disclosure relates to intelligent fitness equipment, and more specifically, to a kettlebell with integrated motion sensors and a kinetic charging system.

### Description of the Related Art

Kettlebell exercises are becoming quite popular among gym members, as well as with those who exercise at home. Typically, kettlebells range in weight from 2 kg to 35 kg. Because of the shape of a kettlebell, its center of mass is extended beyond the hand of the person holding it. This shape provides an unstable force and facilitates exercises that include swinging movements, pulling movements, snatching movements, pressing movements, and clean and jerk movements. These movements can build strength and endurance, making them popular for use in physical therapy and rehabilitation programs. They are also suitable for those interested in achieving their own personal fitness goals.

The digital health industry has been exploding as of late. Many connected health-related devices and wearable health-related devices are currently on the market. However, there are not many comparable intelligent and connected solutions in the area of fitness equipment.

### SUMMARY

In one aspect, a disclosed kettlebell includes one or more sensors to collect movement data during use of the kettlebell, a controller to receive and store the collected movement data, a kinetic charging circuit to charge a battery in the kettlebell, a network interface over which to transmit at least a portion of the collected movement data to a networked device, and a user interface to display a representation of an amount of electricity generated by the kettlebell movement. The kinetic charging circuit may include circuitry to generate electricity to charge the battery using kinetic energy of the kettlebell movement.

In any of the disclosed embodiments of the kettlebell, the one or more sensors may include a gyroscope to determine changes in the orientation of the kettlebell during movement.

In any of the disclosed embodiments of the kettlebell, the one or more sensors may include an accelerometer to measure the physical acceleration experienced by the kettlebell during movement.

In any of the disclosed embodiments of the kettlebell, the controller may include a processor to execute instructions, and a memory storing instructions that when executed by the processor cause the processor to store the collected movement data, sample or aggregate the collected movement data, and cause the sampled or aggregated data to be transmitted to a networked device over the network interface.

In any of the disclosed embodiments of the kettlebell, when executed by the processor, the instructions may further cause the processor to determine the amount of electricity generated by the kettlebell movement, calculate a measure of exercise intensity dependent on the determined amount of electricity generated by the kettlebell movement, and cause the user interface to display an indication of the determined amount of electricity generated by the kettlebell movement or an indication of the calculated measure of exercise intensity.

In any of the disclosed embodiments of the kettlebell, the network interface may implement a wireless communication protocol.

In any of the disclosed embodiments of the kettlebell, the network interface may implement a wired communication protocol.

In any of the disclosed embodiments of the kettlebell, the kettlebell may further include a battery charging circuit, and the network interface implements a wired communication protocol to couple the battery charging circuit to an external battery charger.

In any of the disclosed embodiments of the kettlebell, the user interface may include one or more light emitting diodes, the collective state of which represents the amount of electricity generated by the kettlebell movement.

In another aspect, a disclosed method includes, during movement of a kettlebell, generating, from the movement of the kettlebell using a kinetic charging circuit housed within the kettlebell, electricity, charging, using the generated electricity, a battery housed in the kettlebell, collecting, from one or more sensors housed within the kettlebell, movement data, transmitting, to a networked device over a network interface of the kettlebell, at least a portion of the collected movement data, and displaying, by a user interface element of the kettlebell, a representation of an amount of electricity generated by the movement of the kettlebell.

In any of the disclosed embodiments of the method, the method may further include storing, in a memory housed within the kettlebell, the collected movement data, sampling or aggregating, by a controller housed within the kettlebell, the collected movement data, and transmitting at least a portion of the collected movement data to the networked device may include transmitting the sampled or aggregated data to the networked device.

In any of the disclosed embodiments of the method, the method may further include determining, by a controller housed within the kettlebell, the amount of electricity generated by the movement of the kettlebell, and calculating, by the controller, a measure of exercise intensity dependent on the determined amount of electricity generated by the movement of the kettlebell. Displaying a representation of an amount of electricity generated by the movement of the kettlebell may include displaying an indication of the determined amount of electricity generated by the movement of the kettlebell or an indication of the calculated measure of exercise intensity.

In any of the disclosed embodiments of the method, the one or more sensors housed within the kettlebell may include a gyroscope to determine changes in the orientation of the kettlebell during movement or an accelerometer to measure the physical acceleration experienced by the kettlebell during movement.

In any of the disclosed embodiments of the method, the method may further include receiving, by the networked device over the network interface, the portion of the collected movement data, tracking movement data received over time, and generating information representing effectiveness of a fitness program dependent on the tracked movement data. Tracking the movement data may include storing the portion of the collected movement data and comparing the portion of the collected movement data to previously received movement data.

In any of the disclosed embodiments of the method, the method may further include providing, to a fitness professional, the generated information representing effectiveness of a fitness program.

In any of the disclosed embodiments of the method, generating information representing effectiveness of a fitness program may include calculating, dependent on the tracked movement data, a range of motion achieved by a user of the kettlebell, a change in the range of motion achieved by a user of the kettlebell, an intensity of a workout performed by a user of the kettlebell, or a change in the intensity of workouts performed by a user of the kettlebell.

In any of the disclosed embodiments of the method, the generated information may represent the effectiveness of a fitness program achieved by a first user of the kettlebell and the method may further include providing, to a second user of a kettlebell, the generated information representing the effectiveness of the fitness program achieved by the first user of the kettlebell.

In yet another aspect, a disclosed system includes a first kettlebell and a first networked device. The first kettlebell may include one or more sensors to collect movement data during use of the first kettlebell, a controller to receive and store the collected movement data, a kinetic charging circuit to charge a battery in the first kettlebell during use of the first kettlebell, including circuitry to generate electricity to charge the battery using kinetic energy of the movement of the first kettlebell, a network interface over which to transmit at least a portion of the collected movement data to the first networked device, and a user interface to display a representation of an amount of electricity generated by the movement of the first kettlebell. The first networked device may include a first processor to execute instructions and a first memory. The first memory may store first instructions that when executed by the first processor cause the first networked device to receive the portion of the collected movement data, to store the portion of the collected movement data, to compare the portion of the collected movement data to previously received movement data track movement data, and to generate information representing effectiveness of a fitness program dependent on a result of the comparison.

In any of the disclosed embodiments of the system, the system may further include a cloud-based server. When executed by the first processor, the first instructions may further cause the first networked device to communicate, to the cloud-based server, the portion of the collected movement data or the generated information representing effectiveness of a fitness program. The cloud-based server may include a second processor to execute instructions, and a second memory. The second memory may store second instructions that when executed by the second processor cause the cloud-based server to receive the portion of the collected movement data or the generated information representing the effectiveness of a fitness program, to generate, dependent on the received portion of the collected movement data or generated information representing the effectiveness of a fitness program, data indicating progress made by a first user of the kettlebell in performance of the fitness program, and to provide, to a fitness professional, the data indicating progress made by the first user of the kettlebell.

In any of the disclosed embodiments of the system, the system may further include a second kettlebell and a second networked device. The second kettlebell may include one or more sensors to collect movement data during use of the second kettlebell, a controller to receive and store the collected movement data, a kinetic charging circuit to charge a battery in the second kettlebell during use of the second kettlebell, including circuitry to generate electricity to charge the battery using kinetic energy of the movement of the second kettlebell, a network interface over which to transmit at least a portion of the collected movement data to the second networked device, and a user interface to display a representation of an amount of electricity generated by the movement of the second kettlebell. The second networked device may include a second processor to execute instructions and a second memory. The second memory may store second instructions that when executed by the second processor cause the second networked device to receive the portion of the collected movement data, to store the portion of the collected movement data, to compare the portion of the collected movement data to previously received movement data track movement data, to generate information representing effectiveness of a fitness program dependent on a result of the comparison, and provide, to the first networked device, the portion of the collected movement data received by the second networked device or the information representing the effectiveness of a fitness program that was generated by the second networked device. When executed by the first processor, the first instructions may further cause the first networked device to provide, to the second networked device, the portion of the collected movement data received by the first networked device or the information representing the effectiveness of a fitness program that was generated by the first networked device.

### BRIEF DESCRIPTION OF THE DRAWINGS

For a more complete understanding of the present invention and its features and advantages, reference is now made to the following description, taken in conjunction with the accompanying drawings, in which:

FIG. 1 is a diagram of an embodiment of a system including a connected kettlebell with integrated motion sensors and a kinetic charging system;

FIG. 2 is a block diagram of selected elements of an embodiment of a connected kettlebell with integrated motion sensors and a kinetic charging system;

FIG. 3 is a rendering of an embodiment of a connected kettlebell and its charging station;

FIG. 4 is a rending of another embodiment of a connected kettlebell;

FIG. 5 is a flow diagram of selected elements of a method for operating a connected kettlebell;

FIG. 6 is a flow diagram of selected elements of a method for communicating with a connected kettlebell; and

FIG. 7 is a flow diagram of selected elements of a method for utilizing a connected kettlebell within an exercise program.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As noted above, kettlebell exercises are becoming popular for those doing physical therapy and rehabilitation, and those interested in their own personal fitness goals. As will be described in detail herein, a kettlebell with integrated motion sensors and a kinetic charging system may be well suited for use as an intelligent and connected weight training device in the areas of physical therapy, rehabilitation, and personal fitness. In at least some embodiments of the present disclosure, such a kettlebell may employ one or more movement sensors that are housed inside the kettlebell itself. The movement sensors may include a gyroscope to determine changes in the orientation of the kettlebell during movement and an accelerometer to measure the physical acceleration experienced by the kettlebell during movement. The movement data collected by these sensors may be recorded in a memory within the kettlebell and may also be transmitted to the user's smart device or computer system via a wired or wireless interface.

In at least some embodiments, a kinetic charging unit housed within the kettlebell may charge a battery within the kettlebell that powers the sensors, interfaces, displays, and controllers of the kettlebell, as described herein. In at least some embodiments, the kettlebell may include an integrated user interface, such as a light emitting diode (LED) readout, that displays an indication of the intensity of the user's training as well as the status of the battery. Because the weight of the kettlebell is fixed, the movement data may be very valuable to athletic trainers, physicians, physical therapists, strength and conditioning coaches, and any other fitness professionals or fitness enthusiasts. In at least some embodiments, in addition to providing feedback to the user through one or more user interface elements integrated into the kettlebell, the kettlebells described herein may internally store and pre-process the movement data collected by their sensors and may transmit that collected or pre-processed movement data to networked devices or cloud-based servers for further processing or post-workout analysis.

In some embodiments, through the use of a kettlebell companion application executing on the user's smart device or computer, the user may track their performance and progress with respect to a fitness routine and may share fitness data with others. For example, the user, or a fitness professional, may be able to track increases in strength, exercise intensity, or range of motion over time as a particular fitness routine is repeated. The kettlebell and companion application described herein may allow for the use of highly granular performance metrics for athletes, those doing physical therapy and rehabilitation, and for any others interested in achieving their own personal fitness goals by incorporating kettlebells into their fitness routines. In some embodiments, through the kettlebell companion application executing on the user's smart device or computer, the user may be in communication with a fitness professional for support or assistance, or may be in communication with other kettlebell users with which the user is engaged in a competition, whether friendly or otherwise. In some embodiments, the user may, through the companion application executing on their smart phone or computer, provide fitness data to various social media circles, such as a circle of kettlebell users, a circle of friends, or a circle of family members.

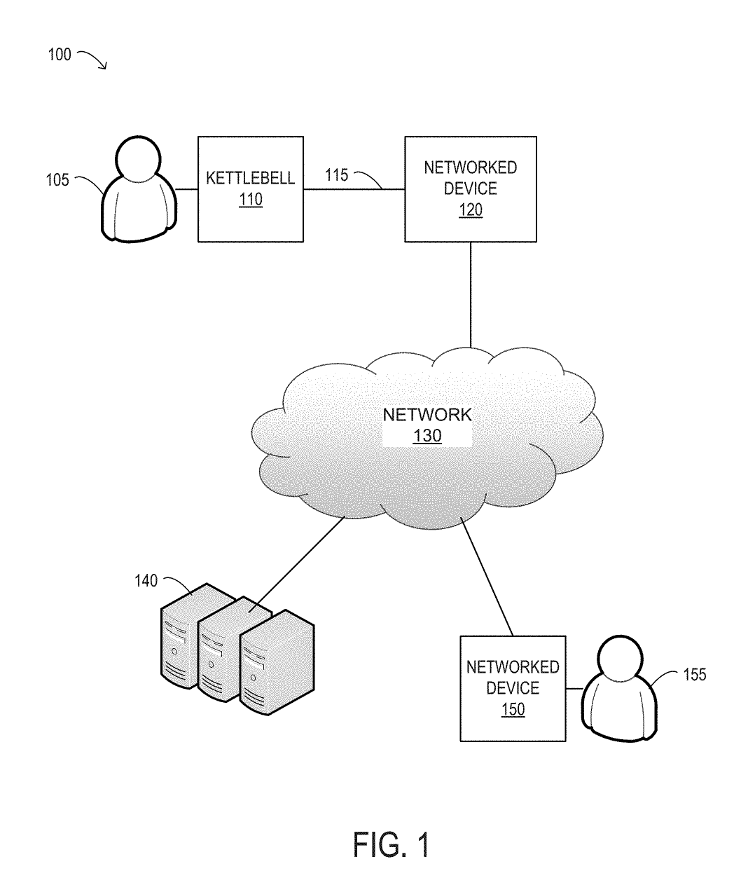

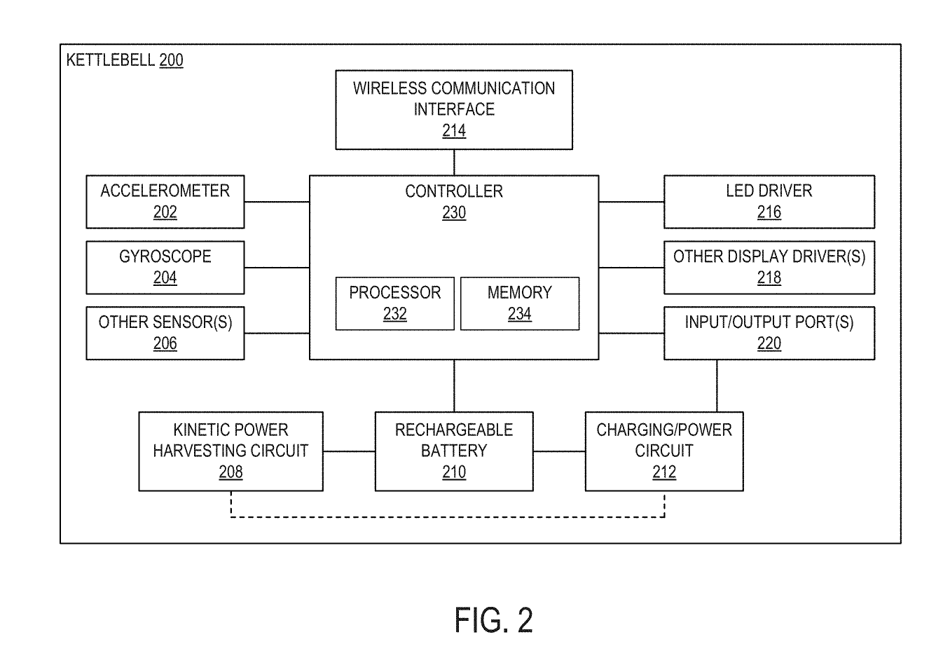

Referring now to the drawings, FIG. 1 is a block diagram of one embodiment of a system 100 including a connected kettlebell with integrated motion sensors and a kinetic charging system. In some embodiments, kettlebell 110 illustrated in FIG. 1 may be implemented by kettlebell 200 illustrated in FIG. 2, which is described in further detail below. In the example embodiment illustrated in FIG. 1, system 100 shows communication between users and devices over various networks. FIG. 1 is a schematic illustration and is not drawn to scale.

In this example embodiment, user 105 is the user of kettlebell 110 for at least one fitness routine including one or more kettlebell movements or kettlebell based exercises. In this example, kettlebell 110 is communicatively coupled to networked device 120 over a local interface 115. In various embodiments, networked device 120 may be a smart phone, a tablet computing device, a gaming device, or another type of smart device. In other embodiments, networked device 120 may be a personal computer, laptop computer, desktop computer, or other computing device. In various embodiments, local interface 115 may include a wireless interface, such as a Bluetooth or Wi-Fi interface, over which kettlebell 110 communicates with networked device 120 during or after the performance of a fitness routine to transmit movement data collected by one or more movement sensors integrated within kettlebell 110 to networked device 120. In some embodiments, local interface 115 may include a wired interface, such as a USB or Micro-USB interface, instead of or in addition to a wireless interface. In such embodiments, kettlebell 110 may communicate with networked device 120 over the wired interface during or after the performance of a fitness routine to transmit movement data to networked device 120. In some embodiments, kettlebell 110 may be communicatively coupled to networked device 120 over the wired interface in order to communicate with a controller housed within kettlebell 110 for initialization or debugging purposes, or to provide a connection to an external battery charger as an alternative battery charging method. In some embodiments, a controller housed within kettlebell 110 may store collected movement data locally and may pre-process the movement data prior to transmitting at least a portion of the collected or pre-processed movement data to networked device 120.

As described in more detail below, networked device 120 may execute a kettlebell companion application that receives movement data from kettlebell 110 and stores the movement data locally on networked device 120. For example, networked device 120 may include a processor (not shown) and a memory (not shown) storing program instructions (i.e., executable code) that when executed by the processor implement a kettlebell companion application. In different embodiments, the processor may include a microprocessor, a system-on-chip (SoC), field programmable logic (such as an FPGA) or in general, any type of circuit containing processing logic that accesses a memory in order to execute instructions to perform the functionality of networked device 120, as described herein. The companion application may also analyze the received movement data to generate training performance or trend information. As illustrated in this example embodiment, networked device 120 may be communicatively coupled to one or more servers 140 over network 130. In some embodiments, at least one of the servers 140 may be a cloud-based server that hosts a cloud-based fitness tracking application that allows users to track their own fitness performance and to share their fitness data with other users through a social media feature of the companion application executing on the networked device 120 or of the cloud-based fitness tracking application. In some embodiments, networked device 120 may transmit to a cloud-based server 140, or a fitness tracking application executing thereon, any of the movement data received from kettlebell 110 or any of the training performance or trend information generated as a result of an analysis performed on kettlebell 110 or networked device 120. For example, networked device 120 may generate or transmit to a server 140 data indicating the range of motion achieved by user 105, a change in the range of motion achieved by user 105, the intensity of a workout performed by user 105, or a change in the intensity of workouts achieved by user 105. In some embodiments, a cloud-based server 140, or a fitness tracking application executing thereon, may further analyze or process movement data or fitness data to learn user tendencies or to generate various types of reports, such as a user profile, a trend analysis or a projection of future performance based on previously received data for the same user or one or more other users.

In the example embodiment illustrated in FIG. 1, user 155 is the user of a networked device 150. In some embodiments, networked device 150 may include a processor (not shown) and a memory (not shown) storing program instructions (i.e., executable code) that when executed by the processor implement a kettlebell companion application. In different embodiments, the processor may include a microprocessor, a system-on-chip (SoC), field programmable logic (such as an FPGA) or in general, any type of circuit containing processing logic that accesses a memory in order to execute instructions to perform the functionality of networked device 150, as described herein. In this example, user 155 may represent a person who has an interest in the results of the performance of a fitness routine by user 105. For example, user 155 may be a fitness professional, such as a physician, a physical therapist, or a personal trainer who is monitoring the progress of user 105 as user 105 performs a fitness routine one or more times. In another example, user 155 may be a friend, a family member, a training partner, or another kettlebell user with whom user 105 shares fitness data, including the movement data received from kettlebell 110 or any of the training performance or trend information generated as a result of an analysis performed on kettlebell 110 or networked device 120. In this example embodiment, networked device 150 may be communicatively coupled to one or more of servers 140 over network 130. User 155 may, through a kettlebell companion application executing on networked device 150, obtain fitness data, including the movement data received from kettlebell 110 or any of the training performance or trend information generated as a result of an analysis performed on kettlebell 110 or networked device 120, that was uploaded to the server 140 through the companion application executing on networked device 150 and stored on the server 140.

In some embodiments, user 155 may also perform a fitness routing using a connected kettlebell similar to kettlebell 110 (not shown). In such embodiments, users 105 and 155 may, through the kettlebell companion applications executing on their respective networked devices 110 and 150, track each other's fitness progress or performance, challenge each other to reach certain goals, or encourage each other to reach various fitness milestones. In some embodiments, the kettlebell companion application may employ a game format in which kettlebell users compete with each other to reach fitness milestones.

Referring now to FIG. 2, a block diagram of selected elements of one embodiment of a connected kettlebell 200 with integrated motion sensors and a kinetic charging system is illustrated. FIG. 2 is a schematic illustration and is not drawn to scale. FIG. 2 illustrates various elements housed with kettlebell 200 to provide the functionality of kettlebell 200, as described herein. It is noted that in other embodiments, kettlebell 200 may include more, fewer or different elements than those shown in FIG. 2.

In FIG. 2, kettlebell 200 is shown including several sensors (shown as 202, 204, and 206), a controller 230, a wireless communication interface 214, several input/output and display elements (shown as 216, 218, and 220), a rechargeable battery 210, and two charging/power circuits (shown as 208 and 212). In this example embodiment, the sensors integrated within kettlebell 200 include an accelerometer 202 to measure the physical acceleration experienced by kettlebell 200 during movement and to provide movement data representing that physical acceleration to controller 230. The integrated sensors also include a gyroscope 204 to determine changes in the orientation of kettlebell 200 during movement and to provide movement data representing the orientation of kettlebell 200, or changes in the orientation of kettlebell 200, to controller 230. In some embodiments, gyroscope 204 may measure the rate of rotation around one or more axes of kettlebell 200 to determine the orientation of kettlebell 200, or to measure the pitch, roll, and yaw attitude angles of kettlebell 200 during movement. As illustrated in FIG. 2, kettlebell 200 may also include one or more other sensors 206, which may include an additional motion sensor, an altitude sensor, a location sensor such as a Global Positioning Sensor (GPS), or a heart rate sensor, in different embodiments.

As illustrated in FIG. 2, controller 230 may include a processor 232 and a memory 234. In different embodiments, processor 232 may include a microprocessor, a system-on-chip (SoC), field programmable logic (such as an FPGA) or in general, any type of circuit containing processing logic that accesses a memory in order to execute instructions to perform the functionality of controller 230, as described herein. In some embodiments, memory 234 may store program instructions (i.e., executable code) that when executed by processor 232 implement at least some of the functionality of kettlebell 200. Controller 230 may be linked to various other elements shown in FIG. 2 for command and control functionality. Controller 230 may include, or be coupled to, additional specific interfaces to support various peripheral elements of kettlebell 200. In some embodiments, some or all of the movement data or other data received from accelerometer 202, gyroscope 204, or other sensors 206 may be stored, at least temporarily, in memory 234. For the purposes of this disclosure, memory 234 may include non-transitory computer-readable media that stores data and instructions for at least a period of time. Memory 234 may comprise persistent and volatile media, fixed and removable media, and magnetic and semiconductor media. Memory 234 may include, without limitation, storage media, random access memory (RAM), read-only memory (ROM), electrically erasable programmable read-only memory (EEPROM), and flash memory; non-transitory media, or various combinations of the foregoing. Memory 234 may, at various times, store instructions, data, or both.

In some embodiments, accelerometer 202, gyroscope 204, and/or other sensors 206 may collect data continuously, as long as battery 210 of kettlebell 200 has sufficient charge to power these sensors and controller 230. The data collected by these sensors may be provided to controller 230 as it is received. In response to receiving the data collected by these sensors, controller 230 may store at least a portion of the received data in memory 234. For example, in some embodiments, controller 230 may not store all of the data received from these sensors, but may only store a sample of the data received. Subsequently, some or all of the data received from the sensors and stored in memory 234 may be transmitted to a networked device over wireless communication network 214 or through an input/output port 220. In some embodiments, instructions executing on processor 232 may cause the controller to pre-process the data received from the sensors and stored in memory 234 prior to transmitting it to a networked device. For example, the sensor data may be sampled or aggregated by instructions executing on processor 232, and the sampled or aggregated data may be transmitted to the networked device instead of, or in addition to, the collected sensor data.

In embodiments in which wireless communication interface 214 maintains a continuous connection with the networked device during the performance of a fitness routine involving kettlebell 200, the collected or pre-processed sensor data may be transmitted to the networked device as it becomes available. In other embodiments, the collected or pre-processed sensor data may be maintained in memory 234 until and unless kettlebell 200 is subsequently coupled to the networked device over wireless communication interface 214 or through an input/output port 220, at which point some or all of the collected or pre-processed sensor data may be transmitted to the networked device. In still other embodiments, portions of the collected or pre-processed sensor data may be transmitted to the networked device periodically when kettlebell 200 is coupled to the networked device over wireless communication interface 214 or through an input/output port 220. In some embodiments, the collected or pre-processed sensor data may be evicted from memory 234 immediately after it has been transmitted to the networked device. In other embodiments, collected or pre-processed sensor data may not be evicted from memory 234 until a pre-determined amount of time has passed following its transmission to the networked device or until space in memory 234 is needed for more recently collected sensor data. For example, controller 230 may be programmed, through instructions executed by processor 232, to cause collected or pre-processed sensor data to be transmitted once every five minutes while kettlebell 200 is coupled to a networked device, in response to the activation of a kettlebell companion application executing on the networked device, in response to a request to shut down the kettlebell companion application, or following a predetermined amount of time after kettlebell 200 has stopped moving, in different embodiments.

In various embodiments, wireless communication interface 214 may implement a standard wireless communication protocol to provide, for example, Wi-Fi or Bluetooth connectivity between kettlebell 200 and a networked device, such as a computer or smart device. In some embodiments, input/output ports 220 may implement a wired communication protocol, such as an Ethernet, USB, or Micro-USB protocol, with which data may be exchanged between kettlebell 200 and a networked device. In some embodiments, an external charger may be coupled to kettlebell 200 through an input/output port 220 to support an alternative to kinetic power harvesting circuit 208 for charging rechargeable battery 210.

In some embodiments, rechargeable battery 210 may be replaceable within kettlebell 200. In other embodiments, battery 210 may be replaceable within kettlebell 200. In the example embodiment illustrated in FIG. 2, charging/power circuit 212 may include circuitry to charge battery 210 using energy provided by an external battery charger coupled to kettlebell 200 through an input/output port 220. In some embodiments, kinetic power harvesting circuit 208 may include circuitry to generate electricity to charge battery 210 directly. In other embodiments, kinetic power harvesting circuit 208 may generate and provide electricity to charging/power circuit 212 so that it can charge battery 210. This is illustrated in FIG. 2 by the dashed line connecting kinetic power harvesting circuit 208 and charging/power circuit 212.

In at least some embodiments, kinetic power harvesting circuit 208 may provide true wireless charging capability for kettlebell 200. For example, the kinetic energy of the kettlebell movement while it is being used for its intended purpose (i.e., facilitating exercise) may provide the necessary activity to activate kinetic power harvesting circuit 208, thus charging battery 210. In some embodiments, the movement of the kettlebell during its use as a connected weight training device may generate enough electricity to charge battery 210 without the need for supplemental charging using an external charger. Kinetic power harvesting circuit 208 may be implemented using custom circuitry or using a standard or commercially available kinetic charging unit that is integrated into kettlebell 200, in different embodiments. In some embodiments, kinetic power harvesting circuit 208 may include a nanogenerator that converts mechanical energy, such as that produced by small physical changes as a result of body movements, into electricity. In one embodiment, a nanogenerator within kinetic power harvesting circuit 208 may include a piezoelectric or triboelectric structure that can convert mechanical energy into electricity.

In the example embodiment illustrated in FIG. 2, kettlebell 200 includes an LED driver 216. In various embodiments, LED driver 216 may include circuitry or logic to control a single LED or multiple LEDs. For example, kettlebell 200 may include a single LED indicator, the intensity or color of which indicates the state of charge of rechargeable battery 210 or the intensity of the exercise being performed by a user. In another example, kettlebell 200 may include a row of LEDs whose collective state indicates the state of charge of rechargeable battery 210 or the intensity of the exercise being performed by a user. In this example, the number of LED that are lit within this LED readout indicates the amount of activity (e.g., in terms of its intensity) or the electricity generated by kinetic power harvesting circuit 208. In some embodiments, kettlebell 200 may include separate single LED indicators or multiple-LED readouts to represent the state of charge of rechargeable battery 210 or the intensity of the exercise being performed by a user, respectively. In other embodiments, different types of user interface elements may be integrated within kettlebell 200 to display an indication of the state of charge of rechargeable battery 210 or the intensity of the exercise being performed by a user.

As illustrated in FIG. 2, in some embodiments, kettlebell 200 may include one or more other display drivers 218. For example, a display driver 218 may include circuitry to control an alphanumeric display indicating the number of calories burned during performance of a fitness routine (as calculated by instructions executing on processor 232 based on the collected sensor data), an altitude, a location, or a heart rate, in different embodiments.

In some embodiments, kettlebell 200 may remain in a low power state when not in use, in order to conserve battery power. For example, some or all of the circuitry within controller 230, sensors 202, 204, and 206, LED driver 216, other display drivers 218, or other components within kettlebell 200 may be powered down until and unless kettlebell 200 is put in motion. In such embodiments, kettlebell 200 may be activated, and its internal elements powered up, either in response to the movement of kettlebell 200 or in response to a command from a networked device coupled to kettlebell 200 (or a kettlebell companion application executing thereon). In at least some embodiments, rechargeable battery 210 may be a relatively large battery, since weight is not likely to be an issue in the kettlebell. In some embodiments, kettlebell 200 may be accompanied by a charging station. In such embodiments, kettlebell 200 may be placed in the charging station between uses so that rechargeable battery 210 is likely to be charged to a state sufficient to power the elements illustrated in FIG. 2 when a user wishes to perform a fitness routine using the kettlebell.

In some embodiments, all of the elements of kettlebell 200 illustrated in FIG. 2 may be implemented on the same printed circuit board or hardware module housed within kettlebell 200. In other embodiments, different subsets of the elements of kettlebell 200 illustrated in FIG. 2 may be implemented on respective ones of multiple printed circuit boards or hardware modules housed within kettlebell 200. In some embodiments, kettlebell 200 may include more, fewer, or different elements, or the functionality of the elements of kettlebell 200 illustrated in FIG. 2 and described herein may be partitioned differently between the elements. In at least some embodiments, any or all of the elements of kettlebell 200 illustrated in FIG. 2 may be implemented either wholly or in part by hardware circuitry or logic to perform the functionality described herein.

In some embodiments, one or more of the sensor components illustrated in FIG. 2 may be implemented in one or more commercially available core modules that includes sensors and sensing algorithms. For example, a UBIQUITOUSWARE core module made available from Fujitsu Limited and integrated within kettlebell 200 may include one or more sensors including, but not limited to, an accelerometer, a gyroscope, a barometer, a pressure sensor, or an environmental sensor (e.g., to measure temperature or humidity). A UBIQUITOUSWARE core module may also implement sensing algorithms that process the output of these sensors into meaningful data, which can then be provided to controller 230. For example, each UBIQUITOUSWARE core module may include a processor and a small memory storing instructions that, when executed by the processor, perform the processing of the raw sensor output into meaningful data. In some embodiments, multiple such modules may be integrated together and may be integrated within kettlebell 200. In other embodiments, at least some of the sensors illustrated in FIG. 2 may be implemented using stand-alone components that integrated within kettlebell 200, and their associated sensing algorithms may be implemented using custom circuitry (which may include various analog-to-digital convertors) or by the execution of program instructions by controller 230 for that purpose.

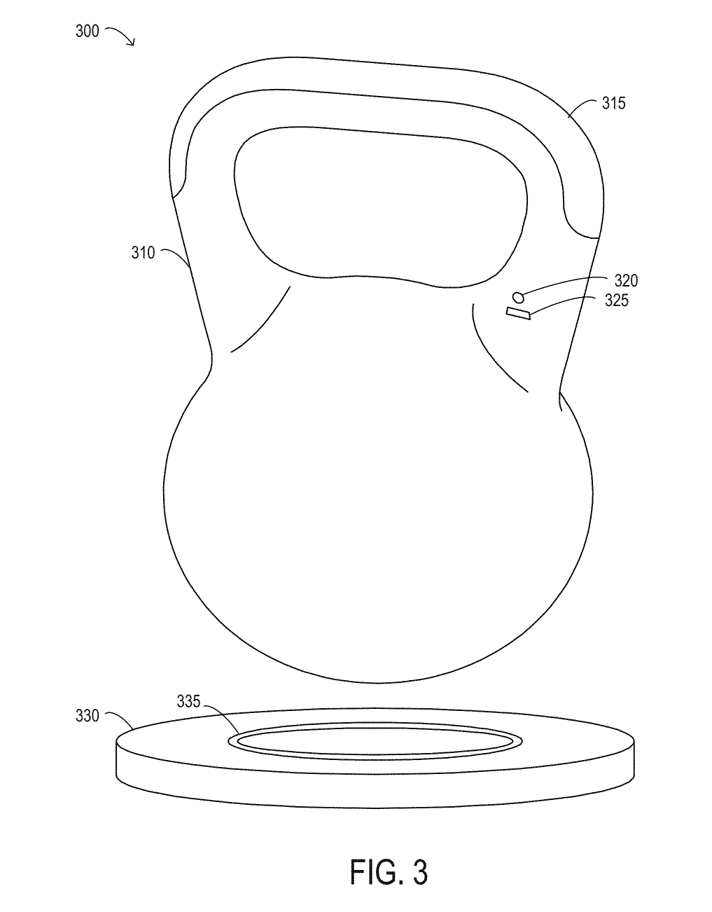

Turning now to FIG. 3, renderings of an embodiment of a connected kettlebell 310 and a charging station 330 for kettlebell 310 are shown. In some embodiments, kettlebell 300 may represent a stand-alone device implementation of kettlebell 110 shown in FIG. 1 or kettlebell 200 shown in FIG. 2 in which many internal elements are obscured from view. Visible in kettlebell 300, in this example embodiment, are an LED indicator (320) and a Micro-USB port (325). In some embodiments, kettlebell 300 may be coupled to a networked computer through a wired connection to Micro-USB port 325 for data transfer, for initialization or programming of kettlebell 300, or in order to perform debugging. In some embodiments, kettlebell 300 may be coupled to an external charger (not shown) through a wired connection to Micro-USB port 325 as an alternative charging method. In this example embodiment, kettlebell 300 includes a single LED indicator 320, the intensity or color of which indicates the state of charge of the battery housed within kettlebell 300 or the intensity of the exercise being performed by a user.

In embodiments in which kettlebell 300 includes an alphanumeric readout to display messages (not shown), the alphanumeric readout may be located in a recessed cavity in the body of kettlebell 300 and may be protected by an relatively unbreakable transparent cover. In some embodiments, kettlebell 300 may include one or more power or mode controls, such as buttons, knobs, or other controls for tactile operation by the user (not shown). For example, a power control on kettlebell 300 may be used to activate kettlebell 300 prior to beginning a fitness routine, or to power down the controller and other circuitry housed within kettlebell 300 between uses to conserver battery power.

In some embodiments of the present disclosure, the grip 315 of kettlebell 300 may include one or more sensors, which may include a heart rate sensor. In such embodiments, data collected by the sensors in grip 315 may be provided to the controller housed within kettlebell 300, which may store the data, pre-process it through sampling or aggregation, or transmit the data to a networked device for trend analysis or other processing by a kettlebell companion application executing on the networked device.

In the example embodiment illustrated in FIG. 3, charging station 330 may include two flat surfaces and a circular opening around which a charging contact ring 335 is mounted. Contact charging ring 335, which may be a metal contact ring, may touch the curved sides of kettlebell 300 when it rests in the charging station to provide connectivity for charging the battery within kettlebell 300. In some embodiments, kettlebell 300 may include a charging contact on its surface (not shown) that is to be in contact with charging contact ring 335 when kettlebell 300 is placed in charging station 300 in order to charge the battery. In some embodiments, charging station 330 may include a DC charging jack (not shown) through which charging station 330 is provided power for charging the battery of kettlebell 300. Obscured from view in FIG. 3 are the elements of kettlebell 200 depicted in FIG. 2, which are housed within kettlebell 300.

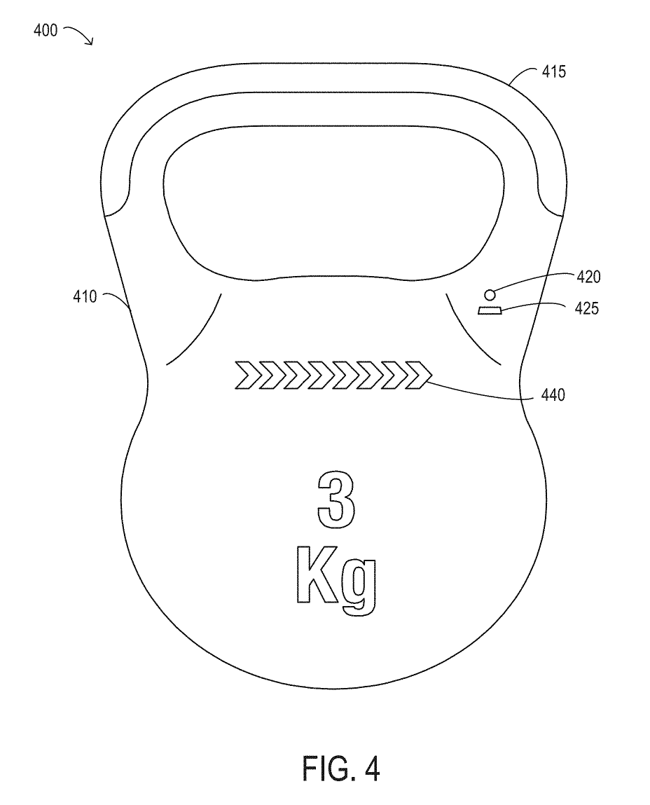

Turning now to FIG. 4, a rendering of an embodiment of a connected kettlebell 400 is shown. In some embodiments, kettlebell 400 may represent a stand-alone device implementation of kettlebell 110 shown in FIG. 1 or kettlebell 200 shown in FIG. 2 in which many internal elements are obscured from view. Visible in kettlebell 400, in this example embodiment, are an LED indicator (420) and a Micro-USB port (425), which may provide the functionality of LED indicator 325 and Micro-USB port 325 illustrated in FIG. 3 and described above. As in the previous example, the grip 415 of kettlebell 400 may include one or more sensors, which may include a heart rate sensor. In such embodiments, data collected by the sensors in grip 415 may be provided to the controller housed within kettlebell 400, which may store the data, pre-process it through sampling or aggregation, or transmit the data to a networked device for trend analysis or other processing by a kettlebell companion application executing on the networked device.

In the example embodiment illustrated in FIG. 4, kettlebell 400 includes an LED readout 440 comprising a row of LEDs across the front of kettlebell 400. In this example, LED readout 440 may show the user the amount of electricity being generated by its movement, which may in turn engage and influence the user to exercise more. In some embodiments, the collective state of the LEDs within LED readout 440 may indicate the state of charge of the battery within kettlebell 400 or the intensity of the exercise being performed by a user. For example, the number of LED that are lit within LED readout 440 at any given time may indicate the current amount of activity (e.g., in terms of its intensity) or the amount of electricity being generated, of that has been generated, by a kinetic power harvesting circuit within kettlebell 400. In some embodiments, kettlebell 400 may include separate single LED indicators or multiple-LED readouts to represent the state of charge of its rechargeable battery or the intensity of the exercise being performed by a user, respectively.

In embodiments in which kettlebell 400 includes an alphanumeric readout to display messages (not shown), the alphanumeric readout may be located in a recessed cavity in the body of kettlebell 400 and may be protected by an relatively unbreakable transparent cover. In some embodiments, kettlebell 400 may include one or more power or mode controls, such as buttons, knobs, or other controls for tactile operation by the user (not shown). For example, a power control on kettlebell 400 may be used to activate kettlebell 400 prior to beginning a fitness routine, or to power down the controller and other circuitry housed within kettlebell 400 between uses to conserver battery power.

Obscured from view in FIG. 4 are the elements of kettlebell 200 depicted in FIG. 2, which are housed within kettlebell 400. In this example, kettlebell 400 is labeled with a weight, in this case, 3 Kg. This may represent the weight of kettlebell 400 including any of the elements depicted within kettlebell 200 in FIG. 2 that are housed within kettlebell 400. Although not shown in FIG. 4, kettlebell 400 may be accompanied by an external charging station, such as charging station 330 illustrated in FIG. 3 and described above.

In at least some embodiments, a connected kettlebell that includes integrated motion sensors and a kinetic charging system, such as kettlebells 200, 300, and 400 described above, may allow a user to track the movement data of the exercises performed using the kettlebell as well as the amount of force being used. The tracking of information may also allow a fitness professional, such as a physician, physical therapist, personal training, or strength and conditioning coach to determine the efficacy of the user's exercises in a highly quantified fashion. In various embodiments, the movement data that is collected, calculated, and tracked using the kettlebells and companion applications described herein may include position data, such as the height of the kettlebell at different points in a movement or exercise, the distance that the kettlebell has been moved in certain directions during a movement or exercise, the amount of force with which the kettlebell is moved, the acceleration of the movement (e.g., how fast the kettlebell is being accelerated) or, in general, any other movement data representing the velocity, intensity, altitude, or direction of the movements of the kettlebell, whether they are side-to-side, up and down, back and forth, or rotating movements.

In at least some embodiments, an integrated gyroscope and an integrated accelerometer may allow users to measure their range of motion in a highly quantified manner. For example, between the data collected from these or other sensor in the collection of sensors integrated within the kettlebells described herein, the range of motion achieved during a movement or exercise may be calculated. This may be particularly useful for users performing a fitness routine for physical therapy or rehabilitation purposes who have goals to increase their range of motion. In some embodiments, the data collected from the sensors integrated within the kettlebells described herein may also be used to determine whether or not the user can lift the kettlebell to certain heights and to track this data over time to see if there is any improvement. For example, a physician or physical therapist working with a patient may be able to access the patient's fitness data to determine if and when the patient is able to lift a 2-lb weight over their head. As described herein, some fitness metrics may be generated by the pre-processing of collected movement data and data collected from other sensors integrated in a kettlebell by a controller within the kettlebell, while other fitness metrics may be generated by further processing of the data or analysis performed on a networked device (or a companion application executing thereon) or cloud-based server (or a fitness tracking application executing thereon) to which this data is transmitted.

In embodiments in which a kettlebell companion application executing on a networked device is a presented in a cloud-based multiuser game format, as a given user is moving a kettlebell during performance of an exercise or fitness routine, the kettlebell may be transmitting collected or pre-processed movement data to the companion application. The companion application may then upload the data to a computer in the cloud that is executing a server portion of the game (with or without first performing additional data processing or analysis). The uploaded data may then be visible to one or more other users engaged in competition with the given user through respective instances of the companion application executing on their own networked devices. Similarly, the given user may be able to view fitness information collected and generated during the performance of an exercise or fitness routine by the other users. In some embodiments, the given user may also post, through the companion application, congratulatory messages to the other users or messages challenging the other users to swing their respective kettlebells higher, with more force, or for a longer period of time than then given user.

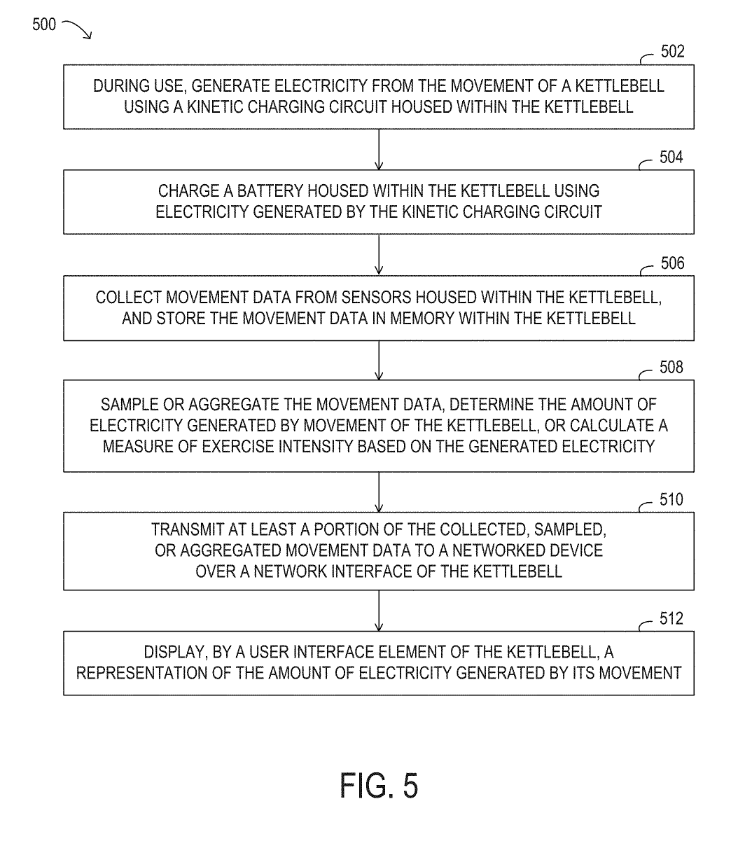

Referring now to FIG. 5, a flow diagram of selected elements of a method 500 for operating a connected kettlebell that includes integrated motion sensors and a kinetic charging system, as described herein, is depicted in flowchart form. Method 500 may be implemented by kettlebell 110 (see FIG. 1), by kettlebell 200 (see FIG. 2), by kettlebell 300 (see FIG. 3) or by kettlebell 400 (see FIG. 4). In some embodiments, the kettlebell may include a controller, such as controller 230 illustrated in FIG. 2, that performs some or all of the operations illustrated in FIG. 5, either wholly or in part. For example, the controller may include a processor and memory storing program instructions that when executed by the processor perform the operations illustrated in FIG. 5. In some embodiments, some or all of the operations illustrated in FIG. 5 may be performed either wholly or in part by hardware circuitry or logic within the kettlebell. In some embodiments, method 500 is repeated as various kettlebell movements are performed by one or more users as part of a fitness routine. It is noted that, in different embodiments, certain operations described in method 500 may be optional or may be performed in an order that is different than that illustrated in FIG. 5.

In the example embodiment illustrated in FIG. 5, method 500 may begin, at 502, by generating electricity from the movement of a kettlebell, during use of the kettlebell, using a kinetic charging circuit housed within the kettlebell. For example, in one embodiment, the kinetic charging circuit may be similar to kinetic power harvesting circuit 208 (see FIG. 2). At 504, the method may include charging a battery housed within the kettlebell using electricity that was generated by the kinetic charging circuit.

At 506, method 500 may include collecting movement data from sensors housed within the kettlebell, and storing the movement data in a memory housed within the kettlebell. For example, the kettlebell may include an accelerometer to measure the physical acceleration experienced by the kettlebell during movement and to provide movement data representing that physical acceleration to a controller within the kettlebell for storage. The kettlebell may also include a gyroscope to determine changes in the orientation of the kettlebell during movement and to provide movement data representing the orientation of the kettlebell, or changes in the orientation of the kettlebell, to a controller within the kettlebell for storage. At 508, the method may include pre-processing the collected movement data. In some embodiments, pre-processing the collected movement data may include sampling or aggregating the movement data. The method may also include determining the amount of electricity generated by movement of the kettlebell, or calculating a measure of exercise intensity based on the generated electricity.

At 510, method 500 may include transmitting at least a portion of the collected, sampled, or aggregated movement data to a networked device over a network interface of the kettlebell. For example, the collected sampled, or aggregated data may be provided to the networked device over a wireless communication interface 214 or an input/output port 220 (see FIG. 2). At 512, the method may include displaying, by a user interface element of the kettlebell, a representation of the amount of electricity generated by its movement. For example, in some embodiments, the state of an LED or the collective state of multiple LEDs may represent the amount of electricity generated by movement of the kettlebell, the current charge state of the battery, or the measure of exercise intensity that was calculated based on the generated electricity. As noted above, any or all of the operations 502-512 of method 500 may repeat over time during one or more exercises or fitness sessions by one or more kettlebell users.

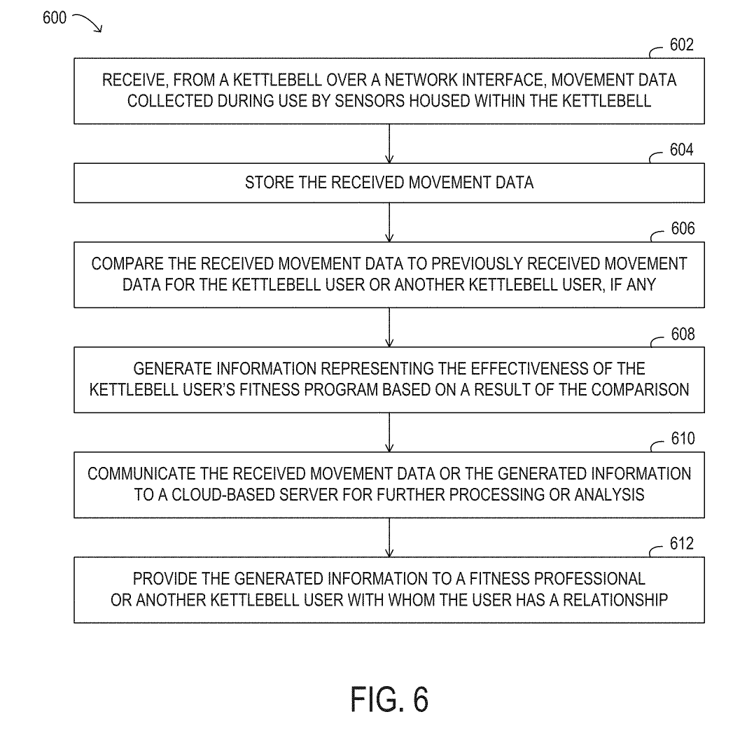

Referring now to FIG. 6, a block diagram of selected elements of a method 600 for communicating with a connected kettlebell that includes integrated motion sensors and a kinetic charging system, as described herein, is depicted in flowchart form. Method 600 may be implemented by networked device 120 (see FIG. 1). In some embodiments, the networked device may include a processor and memory storing program instructions that when executed by the processor perform some or all of the operations illustrated in FIG. 6, either wholly or in part. In some embodiments, some or all of the operations illustrated in FIG. 6 may be performed either wholly or in part by hardware circuitry or logic within the networked device. In some embodiments, method 600 is repeated as the networked device receives movement data or other information from a kettlebell during or subsequent to its use in performing one or more movements or exercises of various fitness routines by kettlebell users. It is noted that, in different embodiments, certain operations described in method 600 may be optional or may be performed in an order that is different than that illustrated in FIG. 6.

In the example embodiment illustrated in FIG. 6, method 600 may begin, at 602, by receiving, from a kettlebell over a network interface, movement data collected by sensors housed within the kettlebell during use of the kettlebell. For example, the kettlebell may include an accelerometer to measure the physical acceleration experienced by the kettlebell during movement and may transmit movement data representing that physical acceleration to the networked device. The kettlebell may also include a gyroscope to determine changes in the orientation of the kettlebell during movement and may transmit movement data representing the orientation of the kettlebell, or changes in the orientation of the kettlebell, to the networked storage device. At 604, the method may include storing the received movement data in a memory for subsequent analysis.

At 606, method 600 may include comparing the received movement data to previously received movement data for the kettlebell user or another kettlebell user, if any. For example, a trend analysis may be performed based on a comparison of recently received movement data to previously received data for the same user or for one or more other users. At 608, the method may include generating information representing the effectiveness of the kettlebell user's fitness program based on a result of the comparison. For example, in various embodiments, the information representing the effectiveness of the kettlebell user's fitness program may include the range of motion achieved by a user of the kettlebell, a change in the range of motion achieved by a user of the kettlebell, the intensity of a workout performed by a user of the kettlebell, or a change in the intensity of workouts performed by a user of the kettlebell.

At 610, method 600 may include communicating the received movement data or the generated information representing the effectiveness of the kettlebell user's fitness program to a cloud-based server for further processing and analysis. For example, a fitness tracking application executing on the cloud-based server may further analyze or process movement data or fitness data to learn user tendencies or to generate various types of reports, such as a user profile, a trend analysis or a projection of future performance based on previously received data for the same user or one or more other users. At 612, the method may include providing the generated information representing the effectiveness of the kettlebell user's fitness program to a fitness professional, such as a physician, physical therapist, or personal trainer of the kettlebell user, or to another kettlebell user with whom the user has a relationship, such as an exercise partner.

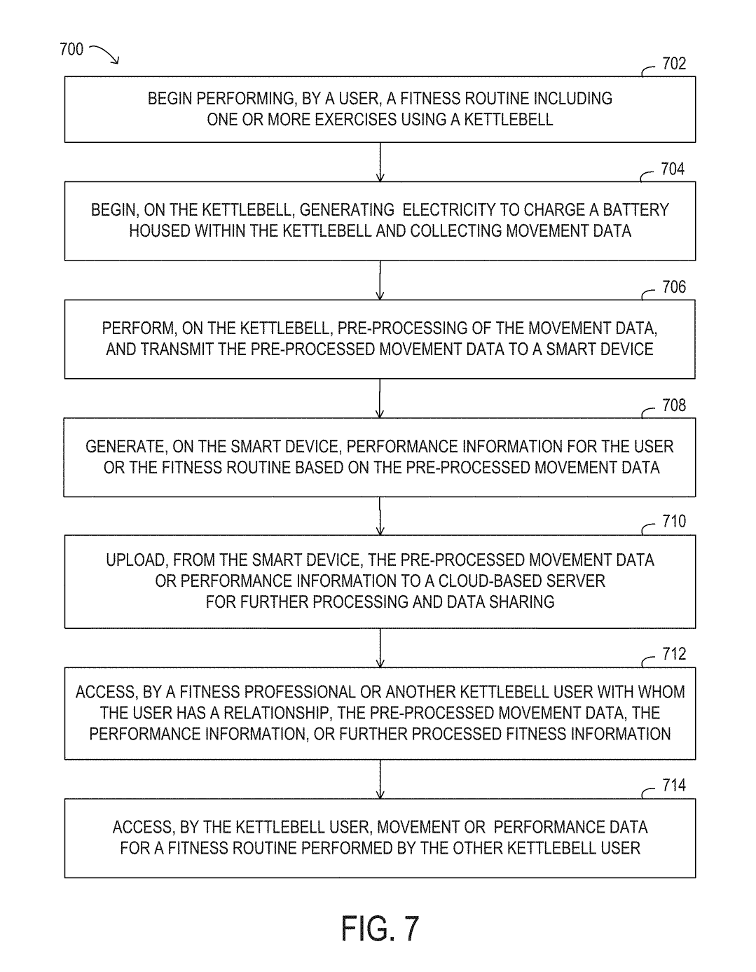

Referring now to FIG. 7, a block diagram of selected elements of a method 700 for utilizing a connected kettlebell that includes integrated motion sensors and a kinetic charging system within an exercise program, as described herein, is depicted in flowchart form. Method 700 may be implemented by a system 100 that includes a kettlebell 110, one or more networked devices 120 or 150, and one or more cloud-based servers 140 (see FIG. 1). In some embodiments, the kettlebell may include a controller, such as controller 230 illustrated in FIG. 2, that performs some or all of the operations illustrated in FIG. 5, either wholly or in part. For example, the controller may include a processor and memory storing program instructions that when executed by the processor perform the operations illustrated in FIG. 5. In some embodiments, some or all of the operations illustrated in FIG. 5 may be performed either wholly or in part by hardware circuitry or logic within the kettlebell. In some embodiments, at least one of the networked devices may include a processor and memory storing program instructions that when executed by the processor perform the operations illustrated in FIG. 6. In some embodiments, some or all of the operations illustrated in FIG. 6 may be performed either wholly or in part by hardware circuitry or logic within the networked device. In some embodiments, method 700 is repeated as the kettlebell is used to perform different movements or exercises by a user, and as movement data is collected and analyzed by a controller housed within the kettlebell, by one of the networked devices, or by one of the cloud-based servers. It is noted that, in different embodiments, certain operations described in method 700 may be optional or may be performed in an order that is different than that illustrated in FIG. 7.

In the example embodiment illustrated in FIG. 7, method 700 may begin, at 702, with a user beginning to perform a fitness routine including one or more movements or exercises using a kettlebell. In some embodiments, beginning the fitness routine may include initializing or signing into a kettlebell companion application executing on a networked device, such as a smart phone, a tablet computing device, gaming device, or a personal computer (not shown). In one example, beginning the fitness routine may include selecting, through the companion application, a fitness routine that the user has previously performed (e.g., for comparison purposes). In another example, beginning the fitness routine may include selecting, through the companion application, a fitness routine that the user has not previously performed. At 704, the method may include beginning to generate electricity on the kettlebell to charge a battery housed within the kettlebell, and beginning to collect movement data. For example, a kinetic charging circuit similar to kinetic power harvesting circuit 208 illustrated in FIG. 2 may begin generating electricity as soon as the user begins performing movements or exercises using the kettlebell. The kettlebell may include an accelerometer to measure the physical acceleration experienced by the kettlebell during movement and may collect, from the accelerometer, movement data representing that physical acceleration. The kettlebell may also include a gyroscope to determine changes in the orientation of the kettlebell during movement and may collect, from the gyroscope, movement data representing the orientation of the kettlebell, or changes in the orientation of the kettlebell.

At 706, method 700 may include performing, on the kettlebell, pre-processing of the movement data, and transmitting the pre-processed movement data to a smart device. In some embodiments, pre-processing the movement data may include sampling or aggregating the collected movement data. At 708, the method may include generating, on the smart device, performance information for the user or the fitness routine based on the pre-processed movement data. For example, in some embodiments, a kettlebell companion application executing on the smart device may calculate, dependent on the pre-processed movement data, the range of motion achieved by the user of the kettlebell, a change in the range of motion achieved by the user of the kettlebell over time, the intensity of a workout performed by the user of the kettlebell, or a change in the intensity of workouts performed by the user of the kettlebell over time.

At 710, method 700 may include uploading, from the smart device, the pre-processed movement data or performance information to a cloud-based server for further processing and data sharing. For example, a cloud-based fitness tracking application executing on the cloud-based server may further analyze or process the pre-processed movement data or performance information received from the smart device to learn user tendencies or to generate various types of reports, such as a user profile, a trend analysis or a projection of future performance based on previously received data for the same user or one or more other users. These reports, as well as the pre-processed movement data or performance information received from the smart device, may be shared with other users through a social media feature of the companion app executing on the smart device or of the cloud-based fitness tracking application. At 712, the method may include accessing, by a fitness professional or another kettlebell user with whom the user has a relationship, the pre-processed movement data, the performance information, generated reports, or any further processed fitness information based on the movement data. For example, a physician or physical therapist may view the information to determine the efficacy of the exercised they prescribed for rehabilitation purposes. In another example, another user of the same type of kettlebell or its companion application, such as a kettlebell user in the user's social circle, or another interested party, such as a friend or family member, may access the pre-processed movement data, the performance information, generated reports, or any further processed fitness information based on the movement data through a respective instance of the companion application executing on their own networked devices to follow the user's progress toward meeting their fitness goals. At 714, the method may also include accessing, by the kettlebell user, movement or performance data for a fitness routine performed by the other kettlebell user. As illustrated in this example, two or more kettlebell users may exchange fitness performance information by accessing the information on a cloud-based server through the companion apps on their respective smart devices.

In at least some embodiments, a connected kettlebell that includes integrated motion sensors and a kinetic charging system, such as those described herein, may serve as an intelligent weight training device for use during the performance of exercises and fitness routines for users with a variety of fitness goals. The kettlebell may generate electricity to charge its battery using an integrated kinetic charging system. An LED display on the kettlebell may show the user the amount of electricity being generated by its movement, which may in turn engage and influence the user to exercise more. Integrated motion sensors may collect movement data which may be transmitted to a networked device, such as a smart phone, tablet computing device, gaming device, or personal computer, for further processing and analysis. The collected and processed data may be uploaded to a cloud-based server, which may learn user tendencies, generate user profiles, or generate trend or progress reports for one or more users. Kettlebell users may share their fitness performance information with friends, family members, or fitness professionals through a kettlebell companion application executing on a networked device that is coupled to a kettlebell over a wireless or wired connection. In some embodiments, users may participate in competition and games by sharing their fitness performance data over social media.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A kettlebell, comprising:
one or more sensors to collect movement data during use of the kettlebell;
a controller to receive and track the collected movement data;
a kinetic charging circuit to charge a battery in the kettlebell, including circuitry to generate electricity to charge the battery using kinetic energy of the kettlebell movement;
a network interface over which to transmit at least a portion of the collected movement data to a networked device;
a user interface to display a representation of an amount of electricity generated by the kettlebell movement.

2. The kettlebell of claim 1, wherein:
the one or more sensors include a gyroscope to determine changes in the orientation of the kettlebell during movement.

3. The kettlebell of claim 1, wherein:
the one or more sensors include an accelerometer to measure the physical acceleration experienced by the kettlebell during movement.

4. The kettlebell of claim 1, wherein the controller comprises:
a processor to execute instructions;
a memory storing instructions that when executed by the processor cause the processor to:
store the collected movement data;
sample or aggregate the collected movement data;
cause the sampled or aggregated data to be transmitted to a networked device over the network interface.

5. The kettlebell of claim 4, wherein:
when executed by the processor, the instructions further cause the processor to:
determine the amount of electricity generated by the kettlebell movement;
calculate a measure of exercise intensity dependent on the determined amount of electricity generated by the kettlebell movement;
cause the user interface to display an indication of the determined amount of electricity generated by the kettlebell movement or an indication of the calculated measure of exercise intensity.

6. The kettlebell of claim 1, wherein the network interface implements a wireless communication protocol.

7. The kettlebell of claim 1, wherein the network interface implements a wired communication protocol.

8. The kettlebell of claim 1, wherein:
the kettlebell further comprises a battery charging circuit;
the network interface implements a wired communication protocol to couple the battery charging circuit to an external battery charger.

9. The kettlebell of claim 1, wherein:
the user interface comprises one or more light emitting diodes, the collective state of which represents the amount of electricity generated by the kettlebell movement.

10. A method, comprising, during movement of a kettlebell:
generating, from the movement of the kettlebell using a kinetic charging circuit housed within the kettlebell, electricity;
charging, using the generated electricity, a battery housed in the kettlebell;
collecting, from one or more sensors housed within the kettlebell, movement data;
transmitting, to a networked device over a network interface of the kettlebell, at least a portion of the collected movement data;
displaying, by a user interface element of the kettlebell, a representation of an amount of electricity generated by the movement of the kettlebell.

11. The method of claim 10, wherein:
the method further comprises:
storing, in a memory housed within the kettlebell, the collected movement data;
sampling or aggregating, by a controller housed within the kettlebell, the collected movement data;
transmitting at least a portion of the collected movement data to the networked device comprises transmitting the sampled or aggregated data to the networked device.

12. The method of claim 10, wherein:
the method further comprises:
determining, by a controller housed within the kettlebell, the amount of electricity generated by the movement of the kettlebell;
calculating, by the controller, a measure of exercise intensity dependent on the determined amount of electricity generated by the movement of the kettlebell;
displaying a representation of an amount of electricity generated by the movement of the kettlebell comprises displaying an indication of the determined amount of electricity generated by the movement of the kettlebell or an indication of the calculated measure of exercise intensity.

13. The method of claim 10, wherein the one or more sensors housed within the kettlebell include a gyroscope to determine changes in the orientation of the kettlebell during movement or an accelerometer to measure the physical acceleration experienced by the kettlebell during movement.

14. The method of claim 10, further comprising:
receiving, by the networked device over the network interface, the portion of the collected movement data;
tracking movement data received over time, including:
storing the portion of the collected movement data;
comparing the portion of the collected movement data to previously received movement data;
generating information representing effectiveness of a fitness program dependent on the tracked movement data.

15. The method of claim 14, further comprising:
providing, to a fitness professional, the generated information representing effectiveness of a fitness program.

16. The method of claim 14, wherein:
generating information representing effectiveness of a fitness program comprises:
calculating, dependent on the tracked movement data, a range of motion achieved by a user of the kettlebell, a change in the range of motion achieved by a user of the kettlebell, an intensity of a workout performed by a user of the kettlebell, or a change in the intensity of workouts performed by a user of the kettlebell.

17. The method of claim 14, wherein:
the generated information represents the effectiveness of a fitness program achieved by a first user of the kettlebell;
the method further comprises:
providing, to a second user of a kettlebell, the generated information representing the effectiveness of the fitness program achieved by the first user of the kettlebell.

18. A system, comprising:
a first kettlebell; and
a first networked device;
wherein the first kettlebell comprises:
one or more sensors to collect movement data during use of the first kettlebell;
a controller to receive and store the collected movement data;
a kinetic charging circuit to charge a battery in the first kettlebell during use of the first kettlebell, including circuitry to generate electricity to charge the battery using kinetic energy of the movement of the first kettlebell;
a network interface over which to transmit at least a portion of the collected movement data to the first networked device;
a user interface to display a representation of an amount of electricity generated by the movement of the first kettlebell;
wherein the first networked device comprises:
a first processor to execute instructions;
a first memory storing first instructions that when executed by the first processor cause the first networked device to:
receive the portion of the collected movement data;
store the portion of the collected movement data;
compare the portion of the collected movement data to previously received movement data;
generate information representing effectiveness of a fitness program dependent on a result of the comparison.

19. The system of claim 18, wherein:
the system further comprises a cloud-based server;
when executed by the first processor, the first instructions further cause the first networked device to:
communicate, to the cloud-based server, the portion of the collected movement data or the generated information representing effectiveness of a fitness program;
the cloud-based server comprises:
a second processor to execute instructions;
a second memory storing second instructions that when executed by the second processor cause the cloud-based server to:
receive the portion of the collected movement data or the generated information representing the effectiveness of a fitness program;
generate, dependent on the received portion of the collected movement data or generated information representing the effectiveness of a fitness program, data indicating progress made by a first user of the kettlebell in performance of the fitness program;
provide, to a fitness professional, the data indicating progress made by the first user of the kettlebell.

20. The system of claim 18, wherein:
the system further comprises:
a second kettlebell; and
a second networked device;
the second kettlebell comprises:
one or more sensors to collect movement data during use of the second kettlebell;
a controller to receive and store the collected movement data;
a kinetic charging circuit to charge a battery in the second kettlebell during use of the second kettlebell, including circuitry to generate electricity to charge the battery using kinetic energy of the movement of the second kettlebell;
a network interface over which to transmit at least a portion of the collected movement data to the second networked device;
a user interface to display a representation of an amount of electricity generated by the movement of the second kettlebell;
the second networked device comprises:
a second processor to execute instructions;
a second memory storing second instructions that when executed by the second processor cause the second networked device to:
receive the portion of the collected movement data;
store the portion of the collected movement data;
compare the portion of the collected movement data to previously received movement data;
generate information representing effectiveness of a fitness program dependent on a result of the comparison;
provide, to the first networked device, the portion of the collected movement data received by the second networked device or the information representing the effectiveness of a fitness program that was generated by the second networked device;
when executed by the first processor, the first instructions further cause the first networked device to:
provide, to the second networked device, the portion of the collected movement data received by the first networked device or the information representing the effectiveness of a fitness program that was generated by the first networked device.
